(19) United States
(12) Patent Application Publication
(10) Pub. No.: US 2008/0106093 A1
(43) Pub. Date: May 8, 2008

(54) Tube connector

(76) Inventor: Thomas L. Hejnicki, Toledo, OH (US)

Correspondence Address: INVENTION PROTECTION ASSOCIATES, LLC, 744 N. Clark Street, #702, CHICAGO, IL, 60610, US

(21) Appl. No.: 11/557,845

(22) Filed: Nov. 8, 2006

(51) Int. Cl. F16L 37/10

(52) U.S. Cl. 285/33; 285/382.2

(57) ABSTRACT

A tube connector for quickly and releasably coupling tubes. The connector is a fully integrated device which connects tubes, end-to-end, by binding to them in spigot fashion with an arbor, traveling nut and expandable collet assembly.

### BACKGROUND OF THE INVENTION

The present invention generally relates to a device for releasably connecting two axially aligned tubes. The invention is specifically directed to a generally linear device having opposing end portions which are to be inserted into the open ends of tubes and then radially expanded by a hand-actuated mechanism.

There are various types of connector apparatuses of the prior art which are adapted to facilitate the quick releasable coupling of tubes. Many such connectors employ bolts, screws or pins which must be inserted through compatible holes in the tubes in order to secure a connection. Unfortunately, shear stress often makes these fastening objects susceptible to yield or even catastrophic failure that eventually necessitates their replacement, if not rendering more serious consequences. Furthermore, since pins, bolts, etc. are generally removable from the connector devices, they can be easily misplaced.

Therefore, it can be appreciated that there exists a need for a truss connector apparatus that is adapted to facilitate a secure coupling of tubes without employing any loose parts that can be misplaced or damaged. The truss connector of the present invention substantially fulfills this existing need.

### SUMMARY

The present invention is a mechanical device for rigidly joining open-ended pipes and tubular objects generally. The constituent major components of a preferred embodiment of the invention include: a pair of arbors, a pair of collets, a pair of traveling collet nuts, a key member and a rotable handwheel for turning the key member, all mounted on a differential screw. One arbor, collet and traveling nut sit side-by-side along a proximal segment of the screw while the other arbor, collet and traveling nut sit side-by-side along its distal segment. The key member is stationed generally within a middle segment of the screw. The rotable handwheel is axially movable within the middle segment, and the handwheel features a taper for receiving the key member.

Both combinations of arbor, collet and nut act as inserting members for being plugged into tubes that the connector device is joining. The handwheel, when engaged with the key member, functions as a means for driving the collet nuts to and fro along the screw and ultimately causing radial expansion of the collets and their consequential binding to the tubes' interior walls. In fact, the present connector facilitates a rigid joining of two tubes by a user following the three successive steps of: (1) slipping the ends of both tubes over the proximal and distal segments of the connector, thereby disposing the connector's arbors, collets and collet nuts within the tubes; (2) sliding the handwheel toward the key and eventually fitting the key into a matching slot along the handwheel; and (3) turning the handwheel (and therefore the screw itself) to propel the collet nuts against the collets, eventually causing radial expansion of the collets and friction binding the expanded collets to the interior walls of the tubes.

It is, therefore, an object of the present invention to provide a tube connector device that rigidly binds tubes together while effectively eliminating the possibility of connection failure due, specifically, to yielding or shearing of the connector's fastening components.

It is another object of the present invention to provide a tube connector device does not employ any loose or unattached parts that can be easily lost. All of the instant connector's components can remain integrated within a single physical apparatus before, during and after the connector is applied in use.

### BRIEF DESCRIPTION OF THE DRAWINGS

FIG. 1 is a perspective view of the tube connector of in a disassembled state;

FIG. 2 is a perspective view of the connector when fully assembled;

FIG. 3 is a perspective view of two tubes being coupled by the connector; and

FIG. 4 is an exploded view of the key member and the arbor to which the key member attaches.

### DETAILED DESCRIPTION OF THE PREFERRED EMBODIMENTS

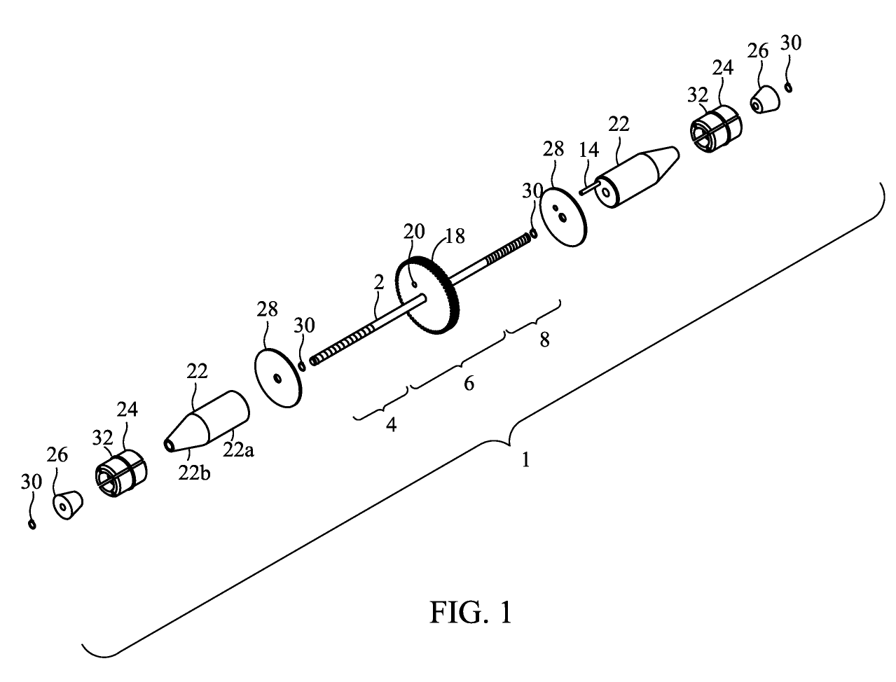

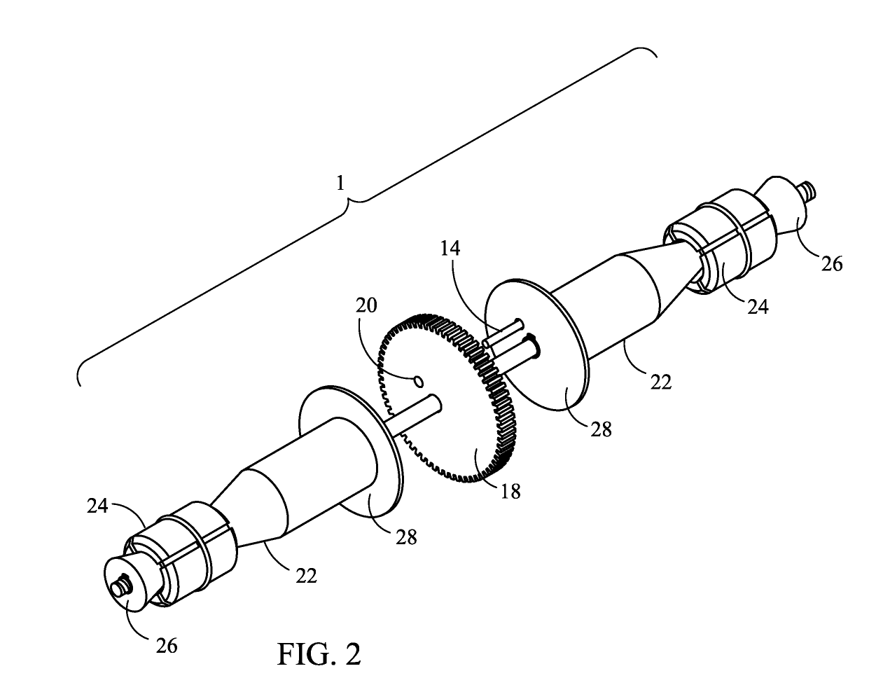

A preferred embodiment of the tube connector 1 of the present invention is illustrated in the accompanying FIG. 1 as fully assembled and FIG. 2 in an unassembled state. The connector 1 is comprised of metal components which are mounted on an elongate differential screw 2. As shown in FIG. 2, the screw 2 comprises three distinct linear segments: a threaded proximal segment 4, a reversely threaded distal segment 8 and an unthreaded middle segment 6.

Referring back to FIG. 1, arranged consecutively along the proximal segment, from near the proximal end of the screw 2 toward its middle segment, are a traveling collet nut 26, a collet 24 and an arbor 22. Similarly, arranged along the distal segment, from near the distal end inward, are another collet nut 26, collet 24 and arbor 22. At both ends of the differential screw 2 are welded-on retaining rings 30 or some other retaining parts for preventing the adjacent collet nuts 26 from traveling off the screw 2.

The arbors 22 each comprise a tubular section 22a and a generally conical tapered section 22b, and they are oriented such that their tapered ends abut the collets 24. The collets 24 are each shaped such that one end wedges over the adjacent arbor's tapered section 22b while the opposite end wedges over the adjacent traveling nut 26. O-rings 32 circumscribe and compress the middles of the collets 24 to further facilitate wedging action.

The screw's middle segment 6 is defined, essentially, as the linear portion of the screw 2 that sits between the arbors 22. At one edge of the middle segment 6, abutting the tubular end of an arbor 22, is a washer 28. Another washer 28 is stationed at the opposite end of the middle segment 6. Immediately next to one washer 28 is a key member 14. In a preferred embodiment of the connector 1, the key 14 is simply a short stud that screws into and protrudes from the tubular end of an arbor 22, as shown in exploded view in FIG. 4. This embodiment of a key 14 pierces a matching bore in the adjacent washer 28 and projects into the middle segment 6 of the screw 2. However, the key device 14 can conceivably take on a number of alternative embodiments of articles stationed within, or immediately adjacent to, the screw's middle segment 6. In any event, the key is fixedly attached to the screw 2 such that the screw 2 will rotate when force acting upon the key 14 revolves the key 14 around the screw axis.

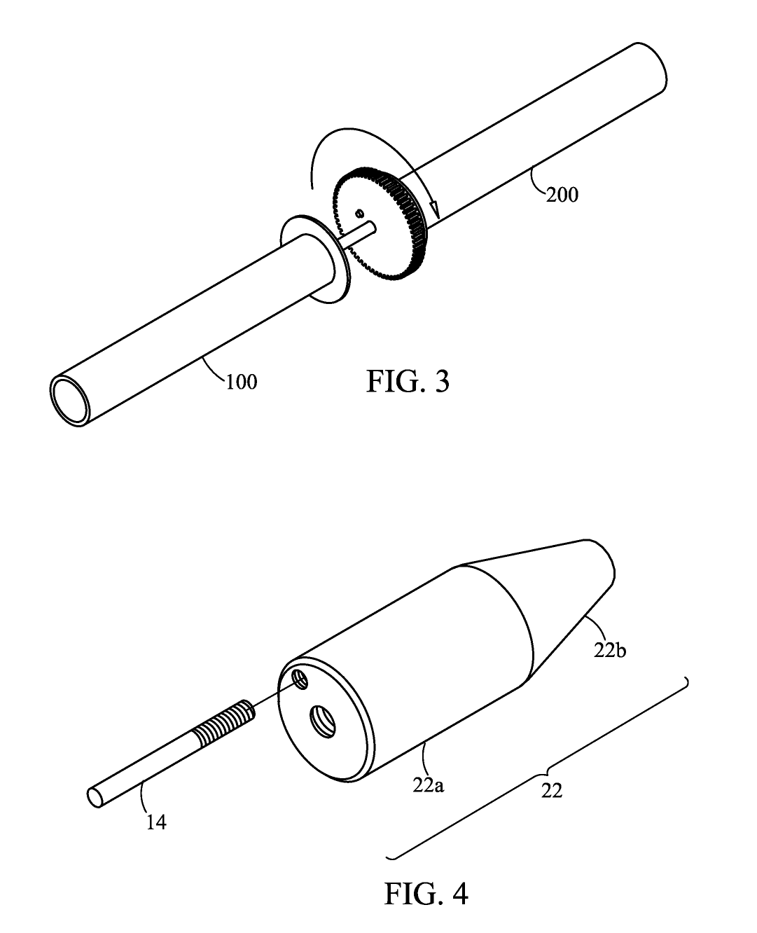

A knurled handwheel 18 is loosely mounted along the screw's middle segment 6 such that a user may slide the handwheel 18 back and forth between the two washers 28. The handwheel 18 features a notch or slot 20 for fitting the key 14 within. Therefore, as illustrated in FIG. 3, the handwheel 18 may be engaged with the key 14 by simply aligning the key slot 20 with the key 14 and then sliding the handwheel 18 over the key 14 so that the key 14 lodges into the slot 20.

The connector 1 joins separate tubes 100,200 at their ends by friction binding itself to their respective interior walls in spigot fashion. A first tube 100 is slid over the proximal segment 4 of the screw 2 such that the end of the tube 100 meets the proximal side washer 28, and the second tube 200 is fitted over the distal segment 8 in like fashion. Thus, in addition to fitting over much of the length of the screw 2, the tubes 100,200 engulf the pairs of arbors 22, collets 24 and collet nuts 26. In fact, the arbors' tubular sections 22a are a push fit within the tubes 100,200.

Once the connector 1 is properly disposed within the tubes 100,200 and the handwheel 18 is engaged with the key device 14 as illustrated in FIG. 3, a user secures the connector 1 to the tubes 100,200 by actuating the collet nuts 26. Specifically, the user turns the rotatable handwheel 18 clockwise. This handwheel 18 rotation revolves the key 14 around the screw axis and thereby rotates the screw 2. However, due to friction between the abutting collet nuts 26 and collets 24, the collet nuts 26 are inhibited from rotating with the screw 2. Instead, both nuts 26 are drawn inward, pressing the collet nuts 26 against the collets 24 and, in turn, the collets 24 against the arbors 22. As the differential screw 2 continues to be rotated, the collet nuts 26 wedge under the collets 24 while the collets 24 wedge over the arbors' tapered sections 22b. The collets' ends radially expand and friction-bind themselves to the interior walls of the tubes 100,200.

When the collets 24 are sufficiently bound to the tubes 100,200, the user discontinues turning the handwheel 18 and slides it off of the key 14. Disengaging the handwheel 18 from the key 14 prevents the handwheel 18 from causing any reverse rotation of the screw 2 and resulting contraction of the collets 24. Of course, to detach the connector 1 from the tubes 100,200, the user simply re-engages the handwheel 18 to the key 14 and then turns the handwheel 18 counterclockwise. This causes the collet nuts 26 to travel outward and relieves sandwiching pressure exerted on the collets 24, allowing the collets 24 to radially contract.

Although the present invention has been described in considerable detail and with reference to and illustration of a preferred version, it should be understood that other versions are contemplated as being a part of the present invention.

What is claimed is:

1. A tube connector comprising:
an inserting member for inserting into ends of tubes; and
actuation means for expanding the inserting member, the expansion causing the inserting member to bind against interior walls of the tubes.

2. The tube connector of claim 1, wherein said inserting member comprises:
a screw;
arbors along the screw;
collets along the screw, wherein the collets are adapted to wedge against the arbors; and
traveling nuts along the screw, wherein the traveling nuts are adapted to cause the collets to wedge against the arbors, the wedging action further causing the collets to radially expand.

3. The tube connector of claim 2, further comprising retaining parts attached to the ends of said screw, the retaining parts for preventing said traveling nuts from traveling off of said screw.

4. The tube connector of claim 2, wherein said actuation means comprises:
a key member fixedly mounted on said screw; and
a rotating member slideably mounted on said screw, the rotating member having a key slot for receiving the key member, wherein the rotating member can be slid into and out of an engaged position that is defined by the key member being fitted into the key slot and wherein rotation of the engaged rotating member causes rotation of said screw, whereby rotation of the engaged rotating member in one direction causes said traveling nuts to move toward said arbors, and rotation of the engaged rotating member in an opposite direction causes said traveling nuts to move away from said arbors.

5. The tube connector of claim 4, wherein said rotating member is a knurled handwheel.

6. The tube connector of claim 4, wherein said screw is a differential screw comprising:
a threaded proximal segment which hosts one of each said arbors, collets and traveling nuts;
a reversely threaded distal segment which hosts the other of each said arbors, collets and traveling nuts; and
a middle segment which hosts said key and rotating members and is of sufficient length to allow said rotating member to slide into and out of the engaged position.

7. The tube connector of claim 6, further comprising retaining parts attached to the ends of said screw, the retaining parts for preventing said traveling nuts from traveling off of said screw

8. A tube connector comprising:
a screw;
arbors along the screw;
collets along the screw, wherein the collets are adapted to wedge against the arbors; and
traveling nuts along the screw, wherein the traveling nuts are adapted to cause the collets to wedge against the arbors, the wedging action further causing the collets to radially expand and bind against interior walls of tubes.

9. The tube connector of claim 8, further comprising retaining parts attached to the ends of said screw, the retaining parts for preventing said traveling nuts from traveling off of said screw.

10. The tube connector of claim 8, wherein said screw is a differential screw.

11. The tube connector of claim 8, further comprising actuation means for moving said traveling nuts axially along said screw.

12. The tube connector of claim 11, wherein said actuation means comprises:
a key member fixedly mounted on said screw; and
a rotating member slideably mounted on said screw, the rotating member having a key slot for receiving the key member, wherein the rotating member can be slid into and out of an engaged position that is defined by the key member being fitted into the key slot and wherein rotation of the engaged rotating member causes rotation of said screw, whereby rotation of the engaged rotating member in one direction causes said traveling nuts to move toward said arbors, and rotation of the engaged rotating member in an opposite direction causes said traveling nuts to move away from said arbors.

13. The tube connector of claim 12, wherein said rotating member is a knurled handwheel.

14. The tube connector of claim 12, wherein said screw is a differential screw comprising:
a threaded proximal segment which hosts one of each said arbors, collets and traveling nuts;
a reversely threaded distal segment which hosts the other of each said arbors, collets and traveling nuts; and
a middle segment which hosts said key and rotating members and is of sufficient length to allow said rotating member to slide into and out of the engaged position.

15. The tube connector of claim 14, further comprising retaining parts attached to the ends of said screw, the retaining parts for preventing said traveling nuts from traveling off of said screw.
